(19) United States
(12) Patent Application Publication
(10) Pub. No.: US 2012/0194566 A1
(43) Pub. Date: Aug. 2, 2012

(54) COMPENSATION CIRCUIT FOR A LIQUID CRYSTAL PANEL

(76) Inventors: Tung-Hsin Lan, Taipei City (TW); Shin-Yuan Peng, Taoyuan County (TW); Shin-Hen Chao, Taoyuan County (TW); Chi-Hu Lin, Taichung City (TW)

(21) Appl. No.: 13/069,378

(22) Filed: Mar. 22, 2011

(30) Foreign Application Priority Data
Jan. 28, 2011 (TW) 100103325

(51) Int. Cl. G09G 3/36; G09G 5/10

(52) U.S. Cl. 345/690; 345/89

(57) ABSTRACT

A compensation circuit for a liquid crystal panel includes a plurality of source scan lines, a plurality of gate scan lines, a plurality of inverse gate scan lines, a plurality of pixel units, and a plurality of compensation units. Each source scan line is used for outputting a data voltage, each gate scan line is used for outputting a control signal, and each inverse gate scan line is used for outputting an inverse control signal. A pixel unit of the plurality of pixel units is charged/discharged to a voltage corresponding to a gray level according to a corresponding control signal and a corresponding data voltage, and a corresponding compensation unit provides a compensation voltage to compensate the voltage corresponding to the gray level according to an inverse control signal.

### BACKGROUND OF THE INVENTION

1. Field of the Invention

The present invention is related to a compensation circuit of a liquid crystal panel, and particularly to a compensation circuit of a liquid crystal panel capable of improving flicker of the liquid crystal panel.

2. Description of the Prior Art

Please refer to FIG. 1A. FIG. 1A is a diagram illustrating a pixel unit 100 of a liquid crystal panel according to the prior art. When a control signal VG outputted by a gate scan line 102 is at a high voltage VDDG, a thin film transistor 104 is turned on and a source scan line 106 charges/discharges a liquid crystal capacitor Clc of the pixel unit 100 to a voltage corresponding to a gray level Vgray according to a data voltage VD, so that a gate voltage of the thin film transistor 104 is at the high voltage VDDG. In addition, as shown in FIG. 1A, Cgd is a parasitic capacitor of the thin film transistor 104, Cs is a voltage stabilization capacitor, and CE is a common electrode of the liquid crystal panel. Please refer to FIG. 1B. FIG. 1B is a diagram illustrating variation of the voltage corresponding to the gray level Vgray of the liquid crystal capacitor Clc due to leakage of the parasitic capacitor Cgd of the thin film transistor 104 when the thin film transistor 104 is turned off according to the control signal VG. As shown in FIG. 1B, when the thin film transistor 104 is turned off according to the control signal VG outputted by the gate scan line 102 (that is, the gate voltage of the thin film transistor 104 is at a low voltage VEEG), the voltage corresponding to the gray level Vgray of the liquid crystal capacitor Clc has a variation voltage Delta Vp due to the leakage of the parasitic capacitor Cgd of the thin film transistor 104, where the variation voltage Delta Vp is determined by equation (1):

Delta Vp=(VDDG−VEEG)×Cgd/(Cs+Clc+Cgd) (1)

In addition, please refer to FIG. 1C. FIG. 1C is a diagram illustrating variation of the high voltage VDDG of the gate scan line 102 with location on the gate scan line 102. As shown in FIG. 1C, because parasitic resistor-capacitor delay of the gate scan line 102 varies with the location of the gate scan line 102, the high voltage VDDG of the gate scan line 102 also varies with the location of the gate scan line 102, resulting in a variation voltage Delta Vp of each pixel unit being different. Thus, when adjusting flicker of the liquid crystal panel, a center of the liquid crystal panel is adjusted to be flicker-free.

Generally speaking, the prior art slices the control signal outputted by the gate scan line to solve the flicker of the liquid crystal panel. However, the sliced control signal reduces charging capacity of a thin film transistor and increases the parasitic resistor-capacitor delay, so the prior art can not be applied to a high frame rate liquid crystal panel.

### SUMMARY OF THE INVENTION

An embodiment provides a compensation circuit of a liquid crystal panel. The compensation circuit includes a plurality of source scan lines, a plurality of gate scan lines, a plurality of inverse gate scan line, a plurality of pixel units, and a plurality of compensation units. Each source scan line of the plurality of source scan lines is used for outputting a data voltage. Each gate scan line of the plurality of gate scan lines is used for outputting a control signal. Each inverse gate scan line of the plurality of inverse gate scan line is used for outputting an inverse control signal. Each pixel unit of the plurality of pixel units has a first terminal coupled to a corresponding source scan line for receiving a data voltage outputted by the corresponding source scan line, a second terminal coupled to a corresponding gate scan line for receiving a control signal outputted by the corresponding gate scan line, a third terminal, and a fourth terminal coupled to a common electrode of the liquid crystal panel for receiving a common voltage. Each compensation unit of the plurality of compensation units has a first terminal coupled to an inverse gate scan line corresponding to the corresponding source scan line, and a second terminal coupled to the third terminal of the pixel unit, where the compensation unit is used for providing a compensation voltage to compensate a voltage of the third terminal of the pixel unit.

The present invention provides a compensation circuit of a liquid crystal panel utilizes a compensation circuit coupled to an inverse gate scan line to compensate a variation voltage of a voltage corresponding to a gray level of a pixel unit due to a parasitic capacitor according to a compensation voltage provided by an inverse control signal outputted by the inverse gate scan line. Thus, the compensation circuit of the present invention not only improves flicker of the liquid crystal panel, but also does not reduce charging capacity of a thin film transistor and increase parasitic resistor-capacitor delay so the compensation circuit of the present invention is suitable for a high frame rate liquid crystal panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating a pixel unit of a liquid crystal panel according to the prior art.

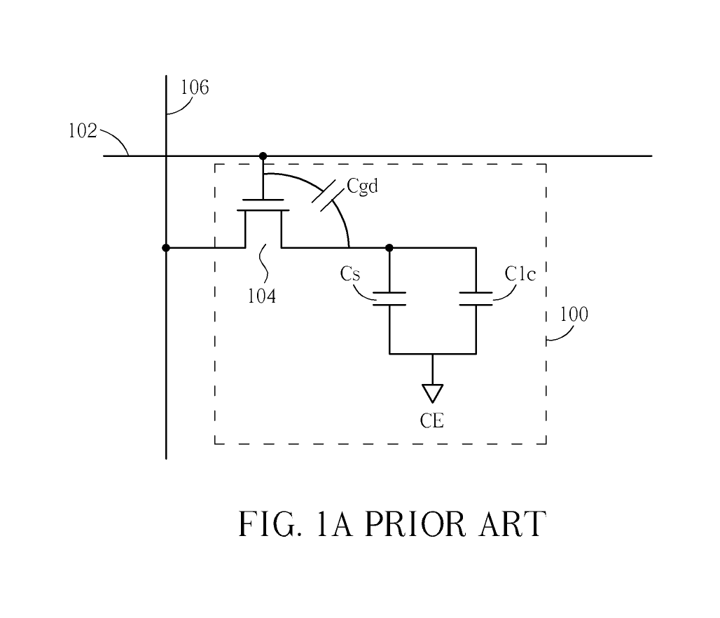

FIG. 1B is a diagram illustrating variation of the voltage corresponding to the gray level of the liquid crystal capacitor due to leakage of the parasitic capacitor of the thin film transistor when the thin film transistor is turned off according to the control signal.

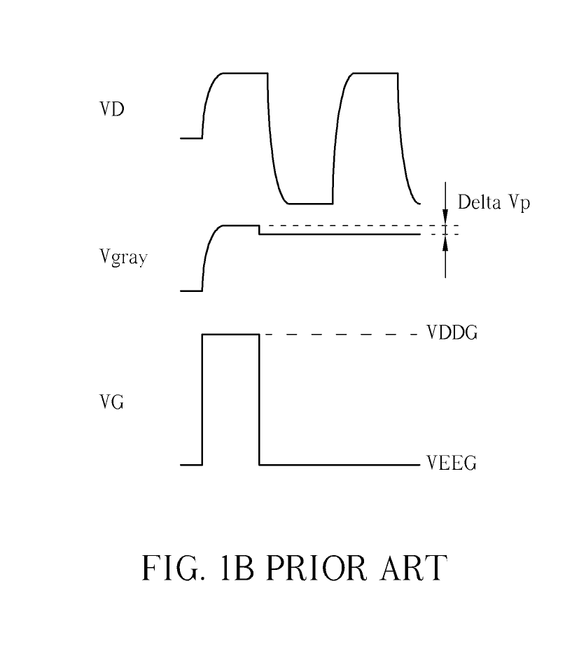

FIG. 1C is a diagram illustrating variation of the high voltage of the gate scan line with location on of the gate scan line.

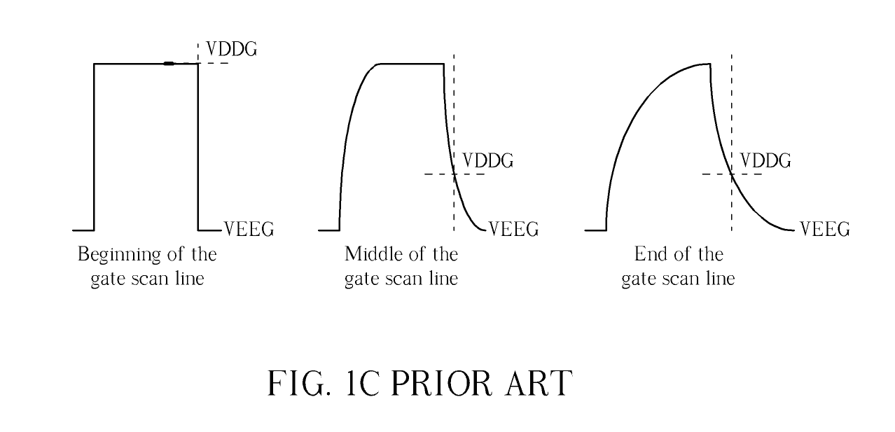

FIG. 2 is a diagram illustrating a compensation circuit of a liquid crystal panel according to an embodiment.

FIG. 3 is a diagram illustrating coupling relationships between a pixel unit, a compensation unit, a source scan line, a gate scan line, and an inverse gate scan line of the compensation circuit.

FIG. 4 is a diagram illustrating the compensation voltage of the compensation unit used to compensate the voltage of the third terminal of the pixel unit.

FIG. 5 is a diagram illustrating coupling relationships between a pixel unit, a compensation unit, a source scan line, a gate scan line, and an inverse gate scan line of the compensation circuit according to another embodiment.

FIG. 6 is a diagram illustrating coupling relationships between a pixel unit, a compensation unit, a source scan line, a gate scan line, and an inverse gate scan line of the compensation circuit according to another embodiment.

### DETAILED DESCRIPTION

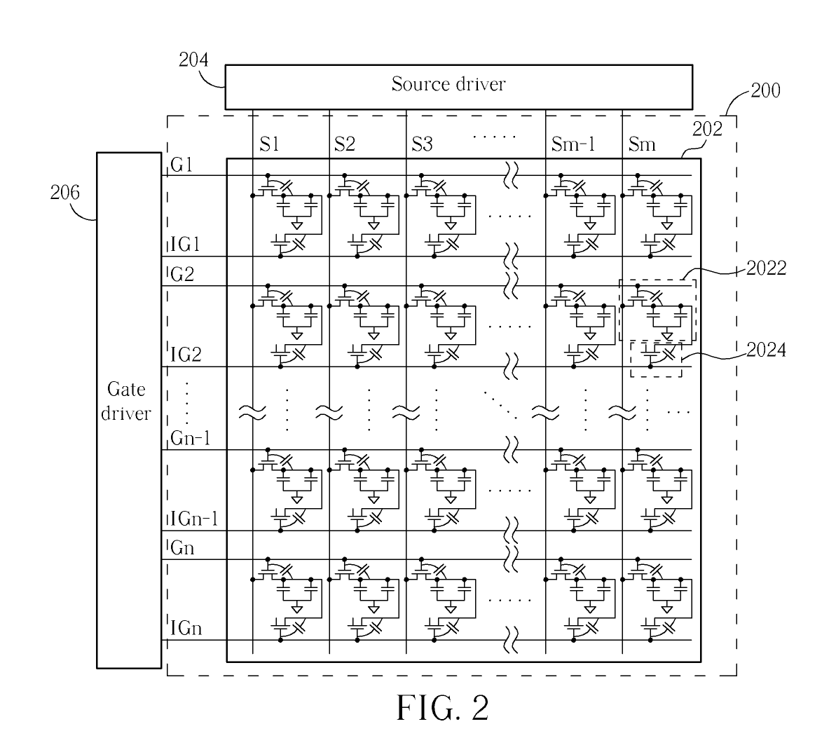

Please refer to FIG. 2. FIG. 2 is a diagram illustrating a compensation circuit 200 of a liquid crystal panel according to an embodiment. The compensation circuit 200 includes a plurality of source scan lines S1-Sm, a plurality of gate scan lines G1-Gn, a plurality of inverse gate scan lines IG1-IGn, a plurality of pixel units 2022 and a plurality of compensation units 2024 of a liquid crystal panel 202. A source driver 204 is used for converting display data to a data voltage, and then each source scan line of the plurality of source scan lines S1-Sm charges/discharges a corresponding pixel unit 2022 to a voltage corresponding to a gray level according to the data voltage. A gate driver 206 is used for controlling the plurality of gate scan lines G1-Gn and the plurality of inverse gate scan lines IG1-IGn, where each gate scan line is used for outputting a control signal and each inverse gate scan line is used for outputting an inverse control signal. In addition, in the compensation circuit 200, number of the plurality of gate scan lines G1-Gn is equal to number of the plurality of inverse gate scan lines IG1-IGn, and number of the plurality of pixel units 2022 is equal to number of the plurality of compensation units 2024.

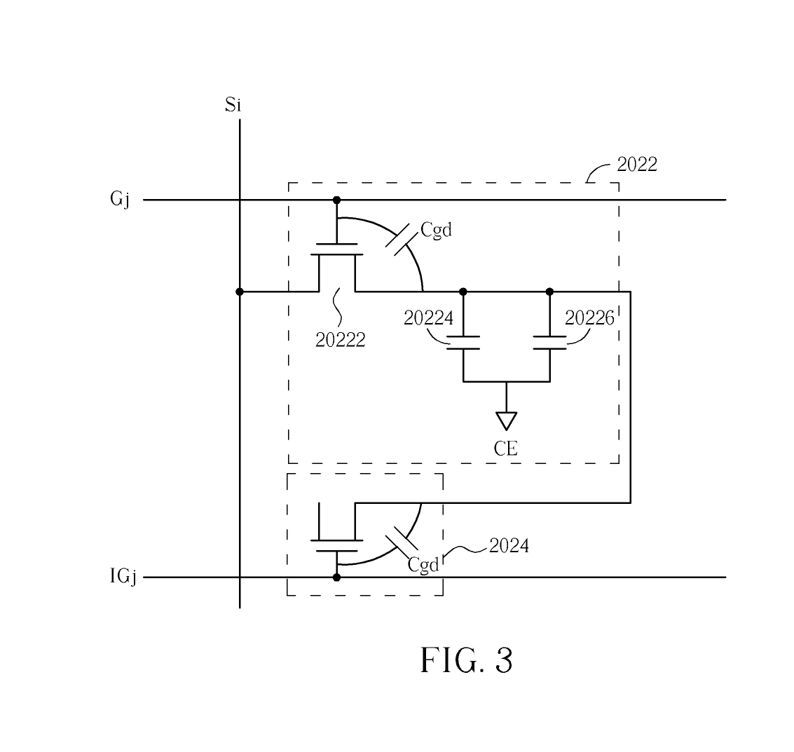

Please refer to FIG. 3. FIG. 3 is a diagram illustrating coupling relationships between a pixel unit 2022, a compensation unit 2024, a source scan line Si, a gate scan line Gj, and an inverse gate scan line IGj of the compensation circuit 200, where 1≦i≦m, and 1≦j≦n. The pixel unit 2022 has a first terminal coupled to the source scan line Si for receiving a data voltage VDi outputted by the source scan line Si, a second terminal coupled to the gate scan line Gj for receiving a control signal VGj outputted by the gate scan line Gj, a third terminal, and a fourth terminal coupled to a common electrode CE of the liquid crystal panel 202 for receiving a common voltage VCE. The compensation unit 2024 has a first terminal coupled to an inverse gate scan line IGj, a second terminal coupled to the third terminal of the pixel unit 2022, and a floating third terminal, where the compensation unit 2024 is used for providing a compensation voltage VC to compensate a voltage of the third terminal of the pixel unit 2022 through the second terminal of the compensation unit 2024, and the compensation unit 2024 is a first N-type thin film transistor and has a parasitic capacitor Cgd.

As shown in FIG. 3, the pixel unit 2022 includes a second N-type thin film transistor 20222, a voltage stabilization capacitor 20224, and a liquid crystal capacitor 20226. The second N-type thin film transistor 20222 has a first terminal coupled to the first terminal of the pixel unit 2022, a second terminal coupled to the second terminal of the pixel unit 2022, and a third terminal coupled to the third terminal of the pixel unit 2022, where the control signal VGj outputted by the gate scan line Gj is used for turning-on and turning-off the second N-type thin film transistor 20222, and the second N-type thin film transistor 20222 also has a parasitic capacitor Cgd the same as the parasitic capacitor Cgd of the compensation unit 2024. The voltage stabilization capacitor 20224 has a first terminal coupled to the third terminal of the pixel unit 2022, and a second terminal coupled to the common electrode CE of the liquid crystal panel 202, where the voltage stabilization capacitor 20224 is used for stabilizing the voltage of the third terminal of the pixel unit 2022. The liquid crystal capacitor 20226 has a first terminal coupled to the third terminal of the pixel unit 2022, and a second terminal coupled to the common electrode CE of the liquid crystal panel 202, where the data voltage VDi of the source scan line Si is used for charging/discharging the liquid crystal capacitor 20226 to a voltage corresponding to a gray level Vgray.

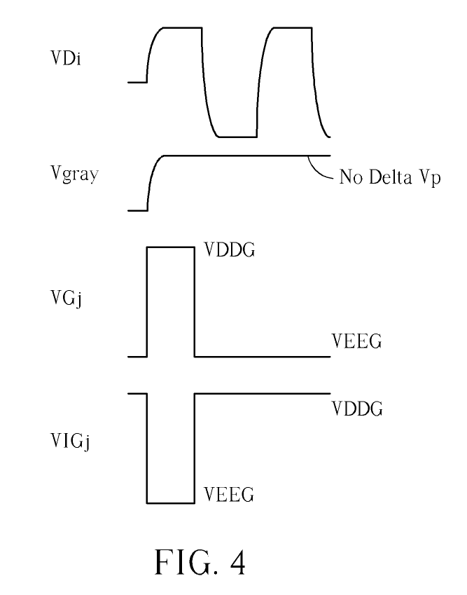

Please refer to FIG. 4. FIG. 4 is a diagram illustrating the compensation voltage VC of the compensation unit 2024 used to compensate the voltage of the third terminal of the pixel unit 2022. As shown in FIG. 4, when the control signal VGj outputted by the gate scan line Gj is at a high voltage VDDG, the second N-type thin film transistor 20222 is turned on, and the liquid crystal capacitor 20226 is charged/discharged to the voltage corresponding to the gray level Vgray according to the data voltage VDi outputted by the source scan line Si. When the control signal VGj outputted by the gate scan line Gj is at a low voltage VEEG, the second N-type thin film transistor 20222 is turned off, and the voltage corresponding to the gray level Vgray of the liquid crystal capacitor 20226 (that is, the voltage of the third terminal of the pixel unit 2022) has a variation voltage Delta Vp due to the parasitic capacitor Cgd of the second N-type thin film transistor 20222, where the variation voltage Delta Vp is determined by the equation (1). However, the inverse control signal VIGj outputted by the inverse gate scan line IGj is changed from the low voltage VEEG to the high voltage VDDG, so the compensation unit 2024 can provide the compensation voltage VC (that is, a negative variation voltage Delta Vp) through the parasitic capacitor Cgd of the compensation unit 2024 to compensate the voltage of the third terminal of the pixel unit 2022. That is to say, the compensation voltage VC can cancel out an influence of the variation voltage Delta Vp on the voltage of the third terminal of the pixel unit 2022.

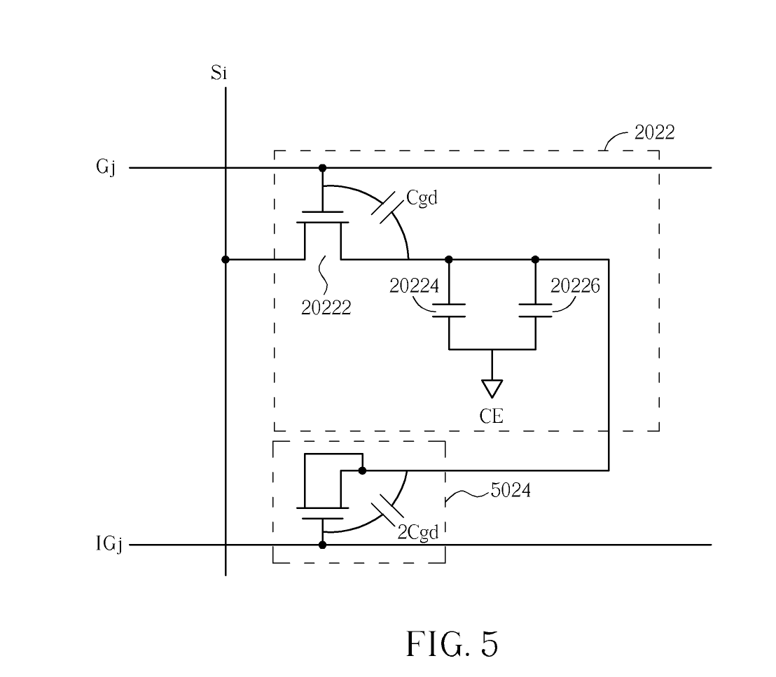

Please refer to FIG. 5. FIG. 5 is a diagram illustrating coupling relationships between a pixel unit 2022, a compensation unit 5024, a source scan line Si, a gate scan line Gj, and an inverse gate scan line IGj of the compensation circuit 200 according to another embodiment, where 1≦i≦m, and 1≦j≦n. A difference between the compensation circuit 5024 and the compensation circuit 2024 is that a third terminal of the compensation unit 5024 is coupled to a second terminal of the compensation unit 5024. Therefore, when a width of the compensation unit 5024 is equal to a width of the compensation unit 2024, a parasitic capacitor of the compensation unit 5024 is 2Cgd. Thus, the width of the compensation unit 5024 can be half of the width of the compensation unit 2024, so that an aperture ratio of the liquid crystal panel 202 is increased. Further, subsequent operational principles of the compensation circuit 5024 are the same as those of the compensation circuit 2024, so further description thereof is omitted for simplicity.

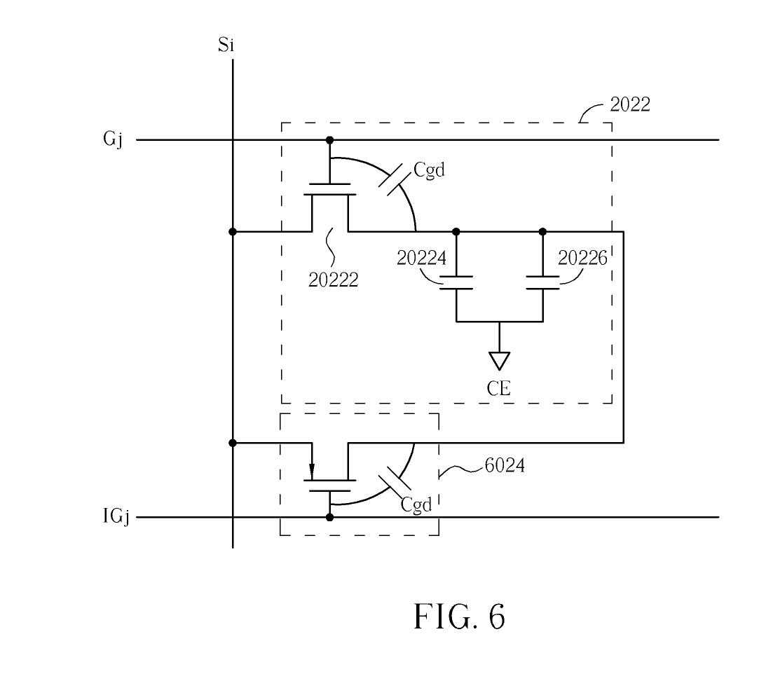

Please refer to FIG. 6. FIG. 6 is a diagram illustrating coupling relationships between a pixel unit 2022, a compensation unit 6024, a source scan line Si, a gate scan line Gj, and an inverse gate scan line IGj of the compensation circuit 200 according to another embodiment, where 1≦i≦m, and 1≦j≦n. A difference between the compensation circuit 6024 and the compensation circuit 2024 is that the compensation unit 6024 is a P-type thin film transistor, and a third terminal of the compensation unit 6024 is coupled to the source scan line Si. Width of the compensation unit 6024 is the same as the width of the compensation unit 2024, so the compensation unit 6024 also has a parasitic capacitor Cgd. Further, sequential operational principles of the compensation circuit 6024 are the same as those of the compensation circuit 2024, so further description thereof is omitted for simplicity.

To sum up, the compensation circuit of the liquid crystal panel utilizes the compensation unit coupled to the inverse gate scan line to compensate the variation voltage of the voltage corresponding to the gray level of the pixel unit due to the parasitic capacitor according to the compensation voltage provided by the inverse control signal outputted by the inverse gate scan line. Thus, the compensation circuit of the present invention not only improves flicker of the liquid crystal panel, but also does not reduce charging capacity of a thin film transistor and increase parasitic resistor-capacitor delay, so the compensation circuit of the present invention is suitable for a high frame rate liquid crystal panel.

Those skilled in the art will readily observe that numerous modifications and alterations of the device and method may be made while retaining the teachings of the invention.

What is claimed is:

1. A compensation circuit of a liquid crystal panel, the compensation circuit comprising:
a plurality of source scan lines, wherein each source scan line is used for outputting a data voltage;
a plurality of gate scan lines, wherein each gate scan line is used for outputting a control signal;
a plurality of inverse gate scan lines, wherein each inverse gate scan line is used for outputting an inverse control signal;
a plurality of pixel units, wherein each pixel unit has a first terminal coupled to a corresponding source scan line for receiving a data voltage outputted by the corresponding source scan line, a second terminal coupled to a corresponding gate scan line for receiving a control signal outputted by the corresponding gate scan line, a third terminal, and a fourth terminal coupled to a common electrode of the liquid crystal panel for receiving a common voltage; and
a plurality of compensation units, wherein each compensation unit has a first terminal coupled to an inverse gate scan line corresponding to the corresponding gate scan line, and a second terminal coupled to the third terminal of the pixel unit, and the compensation unit is used for providing a compensation voltage to compensate a voltage of the third terminal of the pixel unit according to an inverse control signal outputted by the corresponding inverse gate scan line.

2. The compensation circuit of the liquid crystal panel of claim 1, further comprising:
a third terminal of the compensation unit is floating, and the compensation unit is a first N-type thin film transistor.

3. The compensation circuit of the liquid crystal panel of claim 1, further comprising:
a third terminal of the compensation unit is coupled to the second terminal of the compensation unit, and the compensation unit is a first N-type thin film transistor.

4. The compensation circuit of the liquid crystal panel of claim 1, further comprising:
a third terminal of the compensation unit is coupled to the corresponding source scan line, and the compensation unit is a P-type thin film transistor.

5. The compensation circuit of the liquid crystal panel of claim 1, wherein each pixel unit comprises:
a second N-type thin film transistor having a first terminal coupled to the first terminal of the pixel unit, a second terminal coupled to the second terminal of the pixel unit, and a third terminal coupled to the third terminal of the pixel unit, wherein the control signal outputted by the corresponding gate scan line is used for turning-on and turning-off the second N-type thin film transistor;
a voltage stabilization capacitor having a first terminal coupled to the third terminal of the pixel unit, and a second terminal coupled to the common electrode of the liquid crystal panel, wherein the voltage stabilization capacitor is used for stabling the voltage of the third terminal of the pixel unit; and
a liquid crystal capacitor having a first terminal coupled to the third terminal of the pixel unit, and a second terminal coupled to the common electrode of the liquid crystal panel, wherein the data voltage outputted by the corresponding source scan line is used for charging/discharging the liquid crystal capacitor to a voltage corresponding to a gray level.
